(19) United States
(12) Patent Application Publication
(10) Pub. No.: US 2013/0230836 A1
(43) Pub. Date: Sep. 5, 2013

(54) HELMET WITH STAGE BLOOD INDICATOR TO SIMULATE HEAD INJURY

(71) Applicant: MARSHALL STREET ENTERTAINMENT, Manhattan Beach, CA (US)

(72) Inventors: Robert Rosenthal, Manhattan Beach, CA (US); Marc Denny, Hermosa Beach, CA (US)

(73) Assignee: Marshall Street Entertainment, Inc., Manhattan Beach, CA (US)

(21) Appl. No.: 13/773,592

(22) Filed: Feb. 21, 2013

Related U.S. Application Data
(60) Provisional application No. 61/602,045, filed on Feb. 22, 2012.

(51) Int. Cl. G09B 9/00

(52) U.S. Cl. CPC G09B 9/00
USPC 434/262

(57) ABSTRACT

A helmet that both protects the user against injury during a fight and indicates through the cracking of an outer shell and release of stage blood that a blow to the head has been struck sufficient to cause a concussion or bloody head injury to an unprotected head. The helmet includes an inner helmet and outer helmet. The inner helmet is preferably similar in construction to helmets presently used in sports such as football, hockey and bicycling with an absorbent layer next to the user's head, an intermediate soft protective layer and a hard plastic outer layer. On top of the inner helmet, an outer helmet is provided consisting of two plastic shells sandwiching a reservoir of stage blood. For added protection, a visor and neck protector are preferably attached to the helmet.

This application claims priority under 35 USC 119(e) to U.S. Provisional Application No. 61/602,045, filed on Feb. 22, 2012, which is incorporated herein by reference in its entirety for all purposes.

### FIELD OF THE INVENTION

The present invention relates to martial arts accessories, more specifically a helmet which cracks and releases stage blood when a severe blow is made to a fighter's head.

### BACKGROUND OF THE INVENTION

One of the purposes of martial arts, such as kung-fu, karate, judo and stick-fighting, is to teach self-defense skills. If a person is attacked with a knife, stick or gun, for example, it is helpful to have martial arts skills to disarm and subdue the attacker. Because a person may need to react quickly and instinctively in an actual attack, it is valuable for the martial arts training to closely simulate the conditions of an actual attack. The more real the simulation is, the less likely the martial arts participant will freeze up or make an ineffective defense when an actual attack occurs.

One of the problems with simulating an actual attack during martial arts training is that the participant can get badly hurt if they freeze up or make an ineffective defense. Ideally, the martial arts participant will be provided with equipment that can protect them against injury during martial arts training, even if that martial arts training closely simulates an actual attack.

One of the parts of the body that is most vulnerable to serious injury during an actual attack is the head. For example, if the head is struck firmly with a hard stick, the result can be a bloody head injury and/or concussion. It would thus be desirable to have equipment to protect the head during martial arts training while safely demonstrating when a blow is received that would cause serious injury to an unprotected head. By demonstrating when a severe blow is taken to the head, the martial arts participant can learn how to do a better job of protecting the head from serious injury.

Helmets, of course, are a well known means of protecting the head in numerous sports such as football, hockey, bicycling, baseball, skiing and lacrosse. In several prior patents, indicators are provided to demonstrate when a helmet has been damaged by a blow past the point where it can be considered safe for continuing head protection. These prior patents include Rigel's U.S. Pat. No. 6,301,718 (colored liquid from capillary tube released when helmet is irreparably damaged), Rush's U.S. Pat. No. 6,332,226 (cracks on outside of helmet shell indicates that the helmet is no longer safe to use) and Beck's U.S. Pat. No. 7,509,835 (shock detector indicates that helmet is no longer safe to use). Nonetheless, while these prior art helmets indicate when the helmet has been damaged beyond the point of safe use, none of these patents address the problem of demonstrating to a martial arts participant when a blow is struck to the head to the point of causing a concussion or a bloody head injury if the head were unprotected.

Other patents and published applications disclose that reservoirs of stage blood can be inserted into costumes for use in pretending that a bloody injury has occurred. These other patents and published applications include Geller's U.S. Pat. No. 6,093,475 and Cho's PCT Published Application No. WO 2009/005224. The problem with these costumes is that they do not indicate the amount of real harm that must be inflicted before a bloody injury is caused in a real fight. In movies, the pretend fights are usually carefully choreographed before they are filmed to give the appearance of a real fight without actually being a real fight. Sometimes, blood is released as the result of a pretend blow when no real blow has occurred. For example, in Cho's PCT application, an electronic controller is used to determine the release of stage blood. How much blood is released through use of this electronic controller does not appear to have correspondence to the severity of a blow being struck.

What is needed in martial arts is a helmet that both protects the user's head and provides a graphic indicator of how much injury a blow to the head would cause if the head were unprotected.

### BRIEF SUMMARY OF THE INVENTION

The present invention provides a helmet that both protects the user against injury during a fight and indicates through the cracking of an outer shell and/or release of stage blood that a blow to the head has been struck sufficient to cause a concussion or bloody head injury if the helmet were not present. In a preferred embodiment, the helmet includes an inner helmet and outer helmet. The inner helmet is similar in construction to helmets presently used in sports such as football, hockey and bicycling with an absorbent layer next to the user's head, an intermediate soft protective layer (e.g., Styrofoam) and a hard plastic outer layer. Most of the protection against head injury is provided by the inner helmet. On top of the inner helmet, an outer helmet is provided preferably consisting of two plastic shells sandwiching a reservoir of stage blood. For added protection, a visor and neck protector are preferably attached to the helmet of the present invention.

When a blow is struck against the outer shell of the outer helmet by, for example, a stick, an appropriate amount of injury is demonstrated by the outer helmet. For example, if the blow is a light or glancing blow that would not cause noticeable injury to an unprotected head, the outer helmet will not show any appreciable damage. For an intermediate blow, one or more cracks will appear in the outer shell of the outer helmet but no stage blood will be released. For a severe blow that will likely result in concussion or bloody head injury to an unprotected head, the outer shell of the outer helmet will crack open sufficiently to allow stage blood to be released from the outer helmet. Through the flowing blood, it will be apparent to the helmet user and all spectators that a blow has been struck that would have resulted in a serious injury to an unprotected head.

To reduce expense, the outer helmet is preferably separable from the inner helmet. After a severe, stage blood causing blow has been struck to the outer helmet, the damaged outer helmet can be separated from the inner helmet and removed. A new outer helmet can then be attached over the inner helmet to allow continued use of the inner helmet.

### BRIEF DESCRIPTION OF THE DRAWINGS

FIG. 1 shows an undamaged helmet of the present invention.

FIG. 2 shows a cross-sectional view of the helmet of FIG. 1.

FIG. 3 shows the helmet of FIG. 1 receiving an intermediate blow sufficient to crack the outer helmet but not to release stage blood.

FIG. 4 shows the helmet of FIG. 1 receiving a severe blow sufficient to both crack the outer helmet and release stage blood.

FIG. 5 shows a cross-sectional view of the severe blow of FIG. 4 at the moment of impact.

FIG. 6 shows a cross-sectional view of the severe blow of FIG. 4 after stage blood has seeped through cracks in the outer shell.

FIG. 7 shows a perspective view of the FIG. 6 helmet with stage blood seeping through cracks in the outer shell.

FIG. 8 shows a rear view of the helmet of the present invention with a neck protector added.

### DETAILED DESCRIPTION OF THE INVENTION

FIG. 1 shows of a helmet 10 of the present invention in new, undamaged condition. The helmet 10 is especially designed for use in martial arts, including fighting with sticks 12, but can also be used in other contact sports such as hockey, football and lacrosse. First and foremost, the helmet 10 is designed to protect the user's head 16 from injury, such as injury caused by being hit by a stick 12. A face mask 14 is preferably attached to the helmet to additionally protect the user's face from injury. The face mask 14 may be made from a clear, hard plastic, such as acrylic, poly vinyl chloride (PVC) or polypropylene.

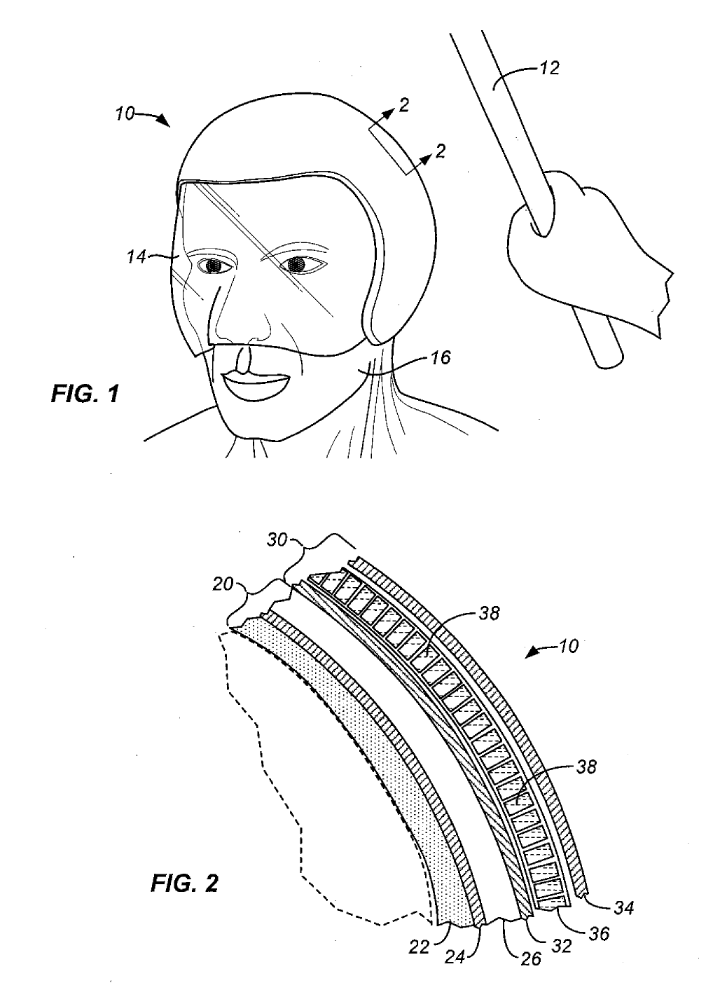

FIG. 2 shows a cross-section of the helmet 10 of FIG. 1. The helmet 10 preferably has an inner helmet 20 and an outer helmet 30. The inner helmet 20 can be similar in construction to helmets used in sports such as football, hockey, lacrosse and bicycling. The inner helmet 20 is preferably constructed of an absorbent layer 22, a soft padding layer 24 and a hard outer layer 26.

The absorbent layer 22 is composed, for example, of absorbent foam material, natural fabric or synthetic fabric. The purpose of this absorbent layer 22 is to wick sweat away from the user's head during sports activity. Outside the absorbent layer 22 is a soft padding layer 24 to cushion the user's head against the shock of any blow struck to the helmet 10. The soft padding layer 24 is preferably constructed of a soft plastic, such as Styrofoam, but may also be constructed of natural or synthetic fabrics. A hard outer layer 26 is preferably formed at the exterior of the inner helmet 20. The hard outer layer 26 is preferably made from a hard plastic, such as acrylic, poly vinyl chloride or polypropylene. The purpose of the hard outer layer 26 is to prevent any blows from contacting the user's head. In an alternative embodiment, the outer helmet 30 can be used as a hard outer layer to thereby dispense with the need to incorporate a hard outer layer 26 into the inner helmet 20.

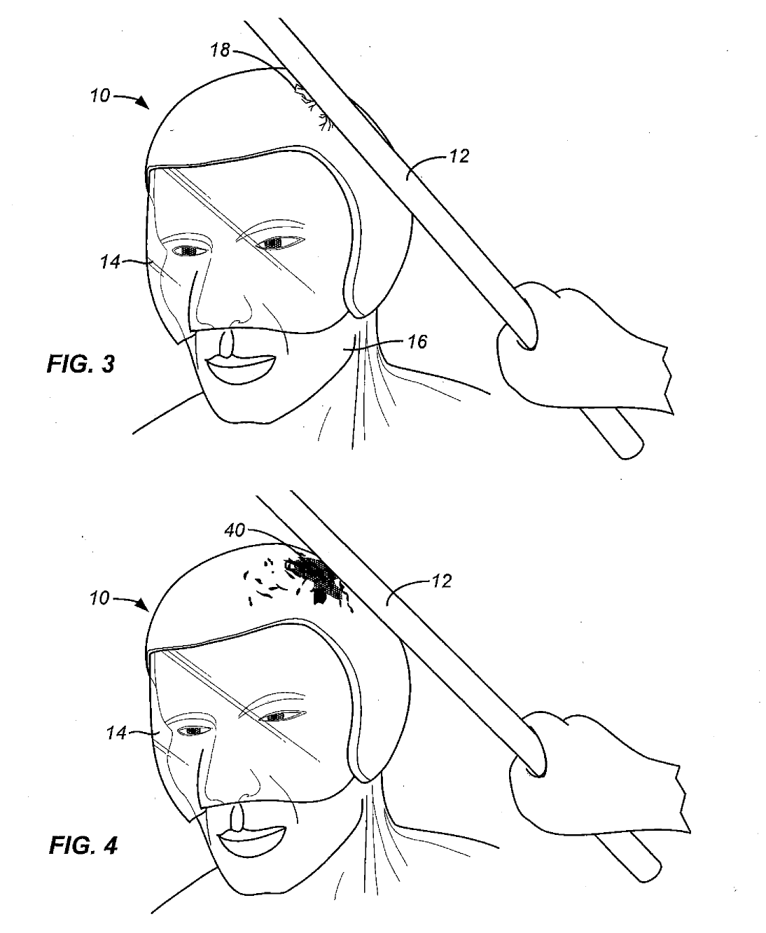

The outer helmet 30 preferably consists of a hard inner shell 32, a hard outer shell 34 and a fluid holding reservoir 36 sandwiched between the two shells. The primary purpose of the outer helmet 30 is to provide an indication of the severity of any blow struck to the helmet 10. The hard inner 32 and outer 34 shells are preferably formed of a hard plastic, such as acrylic, poly vinyl chloride, polyethylene terephthalate (PETG) or polypropylene. To achieve the objectives of the invention, it is particularly important to properly select the material and thickness of the material for the outer shell 34. The material and thickness should be chosen so that a light or glancing blow to the helmet 10 does not result in any appreciable damage to the outer shell 34 in the same way it would not result in any appreciable damage to an unprotected user's head 16. For an intermediate blow, the outer shell 34 should show some cracking (see, FIG. 3), but not so much cracking as to result in the release of fluid from the reservoir 36. Finally, a severe blow to the outer shell 34, which would cause a concussion or a serious bleeding head injury to the user if the user were not wearing the helmet 10, should cause sufficient cracking to the outer shell 34 as to result in the release of fluid 40 from the reservoir 36 (see FIGS. 4 and 6). To achieve these objectives, the thickness of the outer shell 34 will depend upon the material used. In their experiments, for example, the inventors have found that polyethylene terephthalate (PETG) with a thickness between 0.03 and 0.10 inches, preferably around 0.06 inches, may be used for the outer shell 34 to achieve desired results. As those of skill in the art will recognize, other plastics and appropriate thicknesses may be used for the outer shell 34 to achieve the desired results. Since the inner shell 32 does not need to serve this indicator purpose, it can be made thicker than the outer shell 34 to better provide protection to the user.

Between the inner shell 32 and outer shell 34, there is a fluid holding reservoir 36. In one embodiment, this reservoir can be a bladder which would not require tight sealing between the inner shell 32 and outer shell 34. In an alternative embodiment, there is no bladder for the reservoir 36 in which case there should be a leak proof fit between the inner shell 32 and outer shell 34. In this alternative embodiment, a hole (not shown) may be placed in either the inner shell 32 or outer shell 34 after they are formed together for use in filling the reservoir 36 with fluid. The hole should then be sealed after the reservoir 36 is filled with fluid 40 so that fluid will not leak out of the outer helmet 30 before a blow is struck. To help preserve the structural integrity of the outer helmet 30, baffles 38 (FIG. 2) may be built into the reservoir 36 to keep the inner shell 32 and outer shell 34 spaced apart.

The fluid 40 (see, FIGS. 4 and 6) in reservoir 36 is preferably a red colored liquid, such as stage blood. As the fluid is released from the outer helmet 30 after a severe blow (see, FIGS. 4 and 6), use of stage blood will effectively simulate a bloody head wound. If the helmet 10 of the present invention is used in a martial arts competition, the appearance of stage blood after a blow to the helmet 10 may result in the competition being ended. As those of skill in the art will recognize, other types and fluid colors can also be used. To increase the realism of a competition, the outer shell 34 should preferably be colored differently than the fluid 40 so that the fluid can be easily seen when it is released. For example, if stage blood is used for the fluid 40, the outer shell 34 might be colored white or brown. Coloring of the outer shell 34 can be accomplished by, for example, tinting or spray painting the plastic used in the outer shell 34.

Turning now to FIG. 3, an intermediate blow to helmet 10 is shown from stick 12 causing cracks 18 to form in the outer shell 43 of the outer helmet 30. When the helmet 10 receives merely a light or glancing blow, the outer shell 34 will be strong enough to protect the helmet from any noticeable injury. Similarly, such a light or glancing blow to a person's unprotected head would also result in no noticeable injury apart from perhaps a scratch or rash.

When a person's unprotected head is struck with an intermediate blow, there will be some level of damage, such as a temporary stinging pain followed by a bruise. In such case, the person may be able to avoid any external bleeding. This level of intermediate damage is simulated in the helmet 10 of the present invention by the cracking shown in FIG. 3. While this cracking is evidence of damage, it is not so deep or extensive as to result in the release of stage blood 40 from the helmet 10.

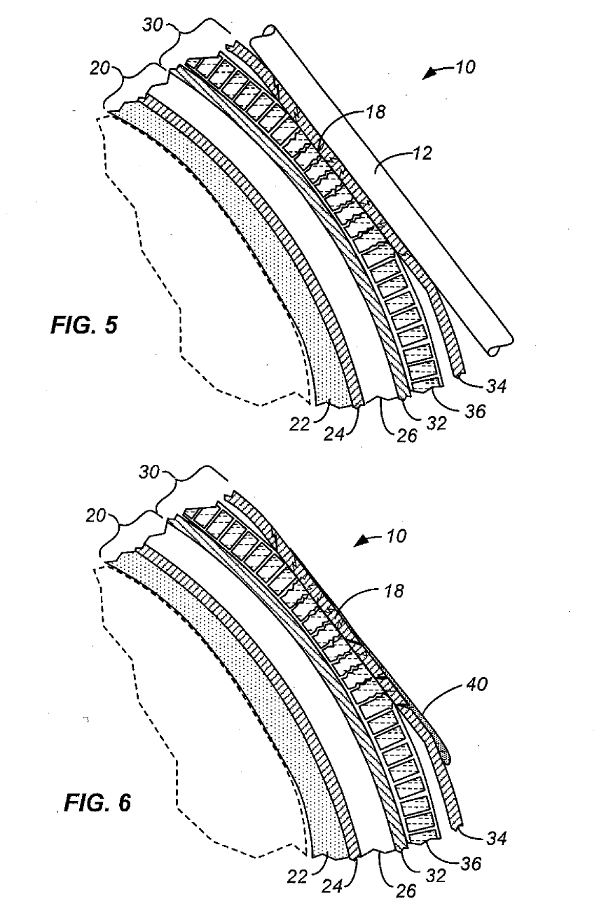

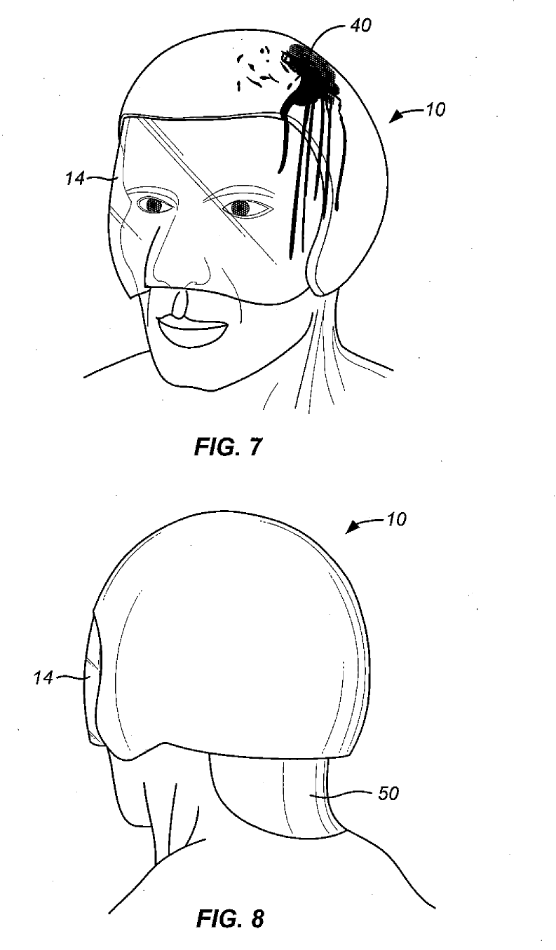

FIG. 4 shows the results of a severe blow to the helmet 10. This corresponds to a blow that would create a concussion or bloody head injury if it were made to an unprotected head 16. As shown in FIGS. 4-6, this severe blow creates cracks 18 in the outer shell 34 of the outer helmet 30 that are either deep or extensive as to result in the release of fluid 40, such as stage blood. As shown in FIG. 7, after such a severe blow is struck, the fluid 40 will continue to flow out of the reservoir 36 and through the cracks 18 in the outer shell 34 even after the blow has ended.

To avoid the need to replace the entire helmet 10 once a severe blow is struck, the helmet 10 can be constructed so that the outer helmet 30 is severable from the inner helmet 20. In that way, after the outer helmet 30 is severely damaged to the extent fluid 40 is released, the outer helmet 30 can be removed and replaced with a new outer helmet 30. In this way, an undamaged inner helmet 20 can continue to be used and need not be replaced. To allow this severability, a mild adhesive can be used to attach the inner shell 32 of the outer helmet 30 where it meets the hard outer layer 26 of the inner helmet 20. This mild adhesive is preferably strong enough to hold the helmet 10 together under normal conditions, but weak enough that the outer helmet 30 can be manually pulled off the inner helmet 20. Alternatively, pegs (not shown) can be formed in the inner shell 32 of the outer helmet 30 which fit into matching holes (not shown) in the hard outer layer 26 of the inner helmet 20, or vice versa. Clips (not shown) can also be used to snap the outer 30 and inner 20 helmets together.

Turning now to FIG. 8, a rear neck guard 50 is attached to the helmet 10 of the present invention to protect the back of the user's neck from blows. If desired, this rear neck guard 50 can be connected to the helmet fluid reservoir 36 to provide visual evidence that a severe blow has been struck. Also, if desired, this rear neck guard can be extended to protect the front of the neck.

In the foregoing specification, the invention has been described with reference to specific preferred embodiments and methods. It will, however, be evident to those of skill in the art that various modifications and changes may be made without departing from the broader spirit and scope of the invention as set forth in the appended claims. The specification and drawings are, accordingly, to be regarded in an illustrative, rather than restrictive sense; the invention being limited only by the appended claims.

What is claimed is:

1. A helmet capable of simulating the extent of injury a blow would cause to an unprotected head comprising:
an inner helmet;
an outer helmet fitting over said inner helmet having a fluid reservoir interposed between said inner helmet and an outer shell;
wherein when a blow is stuck to said helmet that would cause a bloody injury to an unprotected head, said outer shell will crack to the point where fluid will be released from said reservoir and through said outer shell.

2. The helmet of claim 1 wherein said fluid is stage blood.

3. The helmet of claim 1 wherein said fluid reservoir is contained in a bladder

4. The helmet of claim 1 wherein said outer helmet has two plastic shells with said fluid reservoir interposed between them.

5. The helmet of claim 1 wherein said inner helmet comprises an inner absorbent layer, an intermediate soft padding layer and a hard outer layer.

6. The helmet of claim 1 wherein said outer helmet is severable from said inner helmet so that, if said outer helmet is damaged, it can be replaced without having to discard said inner helmet.

7. The helmet of claim 1 further comprising a rear neck guard attached to said helmet.

8. A helmet capable of simulating the extent of injury a blow would cause to an unprotected head comprising:
an inner helmet having an inner absorbent layer, an intermediate soft padding layer and a hard outer layer;
an outer helmet fitting over said inner helmet and having a fluid reservoir interposed between an inner shell and an outer shell of said outer helmet;
wherein when a blow is stuck to said helmet that would cause a bloody injury to an unprotected head, said outer shell will crack to a point where fluid will be released from said reservoir and through said outer shell.

9. The helmet of claim 9 wherein said outer shell is made from polyethylene terephthalate (PETG) with a thickness between 0.03 and 0.10 inches.

10. A method of staging a martial arts competition or performance that allows blows to be struck to a participant's head where head injury can be simulated without actually injuring the participant's head comprising the steps of:
selecting a helmet capable of simulating the extent of injury a blow would cause to an unprotected head comprising an inner helmet having a soft padding layer; an outer helmet fitting over said inner helmet and having a fluid reservoir interposed between an inner shell and an outer shell of said outer helmet; wherein when a blow is stuck to said helmet that would cause a bloody injury to an unprotected head, said outer shell will crack to a point where fluid is released from said reservoir and through said outer shell;
placing said helmet on the head of a martial arts competitor or performance participant; and,
allowing blows to be struck to the head of the martial arts competitor or performance participant until fluid is released from said helmet.
